(19) United States
(12) Patent Application Publication
(10) Pub. No.: US 2006/0173743 A1
(43) Pub. Date: Aug. 3, 2006

(54) Method of realtime allocation of space in digital media based on an advertiser's expected return on investment, ad placement score, and a publisher score

(76) Inventor: Denison W. Bollay, Montecito, CA (US)

Correspondence Address: Denison Bollay, 850 Rockbridge Road, Montecito, CA, 93108, US

(21) Appl. No.: 11/343,988

(22) Filed: Jan. 31, 2006

Related U.S. Application Data
(60) Provisional application No. 60/649,648, filed on Feb. 2, 2005.

(51) Int. Cl. G06Q 30/00

(52) U.S. Cl. 705/14

(57) ABSTRACT

A method of allocating advertising space. Information about a user that is currently accessing the web page is provided to a number of advertiser computational agents, along with statistical data on the relative value of the particular ad placement. These agents compute for an advertiser, the advertiser's “effective Return On Investment” (eROI) for showing an ad impression to this user. eROI prices are received from the eROI agents within an interval after the user is identified and the space is allocated. A publisher computes a “Customer Relevancy Score” (“CRS”), taking into account whether the user will exit if the ad is clicked on (retention), user satisfaction (relevance, context), and content rating (exclusions). Finally, the “Publishers Ad Score” (“PAS”) is computed for the visit, fully reflecting both the advertisers evaluation of the opportunity, and the publisher's interests. Publishers finally select an advertiser in real-time based on the maximum PAS, or rank ads in accordance with the publishers ad score.

### CROSS-REFERENCE TO RELATED APPLICATIONS

This application claims the benefit of provisional patent application Ser. No. 60/649,648, filed 2005 Feb. 2 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to the Internet and more particularly, to a method of allocating ad space in real time on a web page, a video stream, or an audio stream.

### BACKGROUND OF THE INVENTION

2. Prior Art

Advertisers typically advertise their products and services on web pages by banner ads that are graphical representations of products and services being offered. When a user browsing a web page clicks on an ad, a link causes a transfer to the advertiser's web site.

Web sites may allow advertisers to advertise on web pages that fit an advertiser's particular category and charge the advertiser for the advertising space. For example, the advertiser may be charged a fixed fee for every thousand times its banner ad is served up on a web page (CPM, cost per thousand). Alternatively, an advertiser may be charged every time a browser clicks on the advertiser's banner ad (CPC, cost per click).

Merriman (U.S. Pat. No. 5,948,061) teaches that an “advertisement server node selects said advertiser node based on the characteristics of said users”. This is different than the present system, in that advertisers run independent evaluations of the value to be received from running an ad, and then a publisher weights the results, and makes a selection.

Roth, et al. U.S. Pat. No. 6,285,984 teaches using an auction. The present system accomplishes allocation by taking into account the return on investment for an advertiser, and many factors critical to publishers including the likelihood the user will exit if the ad is clicked on (retention), user satisfaction, relevance in the given context, as well as money consideration.

24/7 U.S. Pat. No. 6,026,368 Brown, et Al. teaches “system for providing targeted information to a user in an on-line computer mediated communication including a queue builder for combining a targeting data storage with a plurality of editors and outputting resulting data to a queue generator, and an on-line queue manager including a priority queue storage which receives data from the queue generator.”, a centralized system for building queues, as opposed to completely independent agents, running independent algorithms on separate computers computing the optimum price for the advertiser to pay for an ad impression, arbitrated and weighted by a publisher's algorithm. In the present system, each ad impression is an independent event.

### SUMMARY OF THE INVENTION

Briefly, the invention is concerned with a method of allocating web page space. The user that is currently accessing the web page is identified (if possible) and information about the user is provided to a number of “eROI agents”. An eROI agent is a computer program acting for an advertiser to mathematically compute the expected value to the advertiser for showing this particular ad impression to this user. eROI prices are computed by the eROI agents for an individual ad impression immediately after the ad opportunity arrives (or if user information is to be taken into account, as soon as a user is identified). The effectiveness of the ad placement is also factored in from the Ad Placement Scoring agent.

A “Customer Relevancy Score” is computed by the publisher taking into account factors important to a website like the likelihood of the user remaining on the publisher's site (retention), user satisfaction (relevance, context), and content rating (exclusions). Next, the “Publishers Ad Score” (“PAS”) is computed for each possible ad, fully reflecting both the advertisers evaluation of the opportunity, and the publishers evaluation of the ad. This is done according to an established relationship between the eROI and CRS. Publishers finally select an advertiser in real-time based on the PAS. The space may be allocated to an advertiser whose PAS score is the highest or the space may be allocated in a ranking order in accordance with PAS scores.

The invention has the advantage that it enables an advertiser to compute the expected return on investment for each ad impression, determining the statistical value to be received by showing that ad, according to the past history of the ad placement, the profile of a particular viewer, time of day, or any other pertinent factors to the advertiser. The complexity of the computation is only constrained by the time limit for advertisers to compute an eROI (nominally 100 ms for a banner ad, longer for ads in digital media streams).

The invention has the further advantage that it enables an advertiser to make an ad available to a potential buyer based upon the profile of a particular buyer while the buyer is actually on the web site.

The cost per thousand method of web advertising has the drawback that ads cannot be tailored for the specifics of a particular ad placement or user. The cost per click method has the drawback that a publisher has no basis to determine an ad's appeal and hence the likelihood it will be clicked on and generate revenue for the site. A site gets less money because unappealing ads are clicked less often. Weighting the advertiser's “expected Return on Investment”, with the “Customer Relevancy Score” method used in the present invention is the optimal system for both advertisers (they compute their return on investment), and the publisher's site (they pick ad content that relates to the page context, meets content restrictions, and weighs the cost of losing the viewer if he clicks on a link).

### BRIEF DESCRIPTION OF THE DRAWING

The invention will be described in greater detail with reference to the drawings in which:

FIG. 1 is an overall block diagram of an Internet commerce system in which the present invention is embodied;

FIG. 2 is a flow diagram of computer software implementing advertiser sign-up software;

FIG. 3 is a flow diagram of computer software implementing advertiser ad display software;

FIG. 4 is a diagram of computer software implementing the Ad Placement Scoring Agent software;

### DETAILED DESCRIPTION OF THE INVENTION

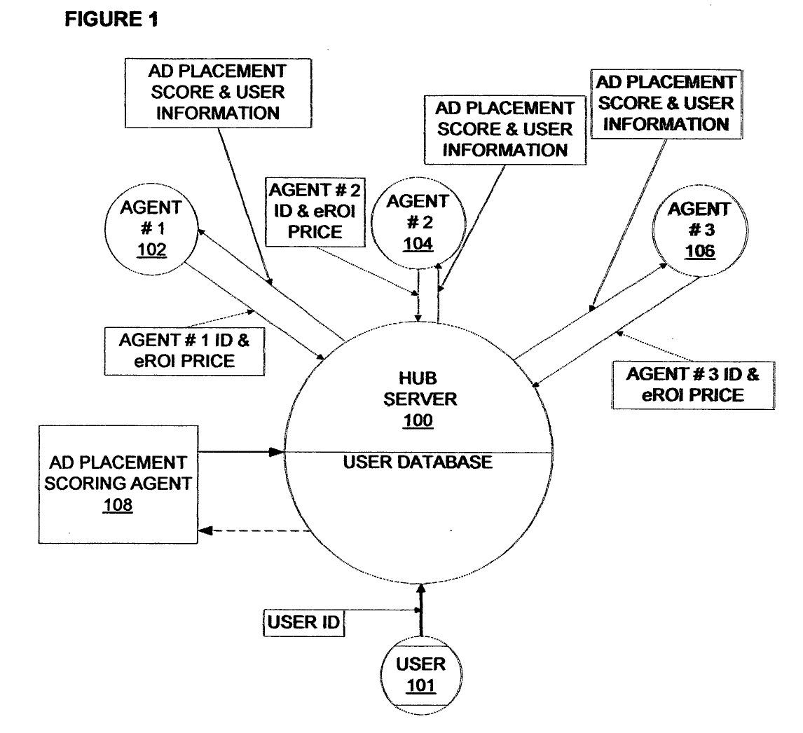

Refer to FIG. 1, which is an overall block diagram of an Internet system in which the present invention is embodied. A hub server 100 provides an advisement (ad) or several advertisements (ads) to be inserted into a space on a web page. As used herein, the term “ad” refers to a graphical image, text only, or a combination of video, sound and text. The ad could be an Internet banner ad, TV ad (video and audio), radio ad (audio). The server causes user information to be sent to each of a number of agents 102, 104, 106, located locally near the hub, or remotely at each advertises site. As used herein, the term “user” refers to a viewer (listener), capable of accessing a digital medium. User identification (ID) includes one or more of a cookie, IP address, MAC address, CPU chip ID, etc. User information includes any known information such as a profile, viewing habits, buying habits, income, email, Internet Service Provider (ISP), zip code or other address information, search terms used, domain name, location, time of day, type of site, etc. On the Internet, an agent is a program that performs some function for an entity automatically without direct supervision.

Agents compare the user's information and location with criteria, such as the advertiser's target audience, as well as the ad placement performance score, time of day and other factors. Agents representing advertisers that are interested in advertising to this particular user, compute an eROI price and send it along with their agent's ID to the hub server. The agent's eROI price is determined by each agent in accordance with a value placed on a user with this user profile, shown with this ad placement (from the Ad Placement Scoring Agent 108), and any other information pertinent to an advertiser.

The hub server 100 computes a “Customer Relevancy Score” (“CRS”) for each potential ad based on the publisher's algorithm, taking into account whether the user will exit if the ad is clicked on (retention), user satisfaction (relevance, context), and content rating (exclusions). Finally, a “Publishers Ad Score” (“PAS”) is computed by the hub server for every potential ad for which an eROI is returned. This final PAS fully reflects both the advertisers evaluation of the opportunity, as well as the publisher's interests. In the preferred embodiment, this is usually computed by taking the product of the eROI and the CRS.

For example, Sony could compute the value of showing a camcorder ad to a 50-year-old high income male is worth one cent (Agent #1, 102). Nestle could compute an eROI of 1.1 cents for a Butterfinger's ad (Agent #2, 104), and the Wall Street Journal an eROI of 0.9 cents (Agent #3, 106). The CRS scores if the ad was to be shown on Yahoo finance might be 0.8 for consumer products, 0.5 for food products, and 1.0 for financial services because of high relevancy respectively. The hub server then selects the ad whose PAS is largest. Thus in this example, the highest PAS score happens to be the lowest price (Wall Street Journal), but will optimize the experience for all parties. The chosen ad is then selected for the user. That ad is displayed on the web page during the time that the potential buyer is browsing the page, interstitial, or popup page. Alternatively, the server arranges a number of ads in a ranking order in accordance with PAS.

Once an ad selection is made, all agents that submitted an eROI are supplied with the winning eROI price, and the publisher's CRS. These features allow agents to adapt to the environment.

Ad Placement Scoring Agent (“APSA”)

Historical statistical information about the click through ratio for each ad placement is collected and maintained in real time by an Ad Placement Scoring Agent (“APSA”). An “ad placement” is a particular place an ad can be shown. Every page of every web site is considered a different placement, as is each separate location on that page. Multiple ads may be placed on a single page: e.g. the top center of the page, ads in the left or right columns etc., but each is considered different.

A separate pair of counters 406, constantly records the number of impressions and the number of clicks for every ad placement is stored in a data structure 404. A reference to the relevant click pairs (for different times) is stored in hash table 402. References to these pairs are also stored in a sorted list 408, ordered by click through ratio (CTR=clicks/impressions). For any given ad placement, the APSA score may be used by an eROI agent, according to an established relationship, to weight the relative values of ads placed in different places.

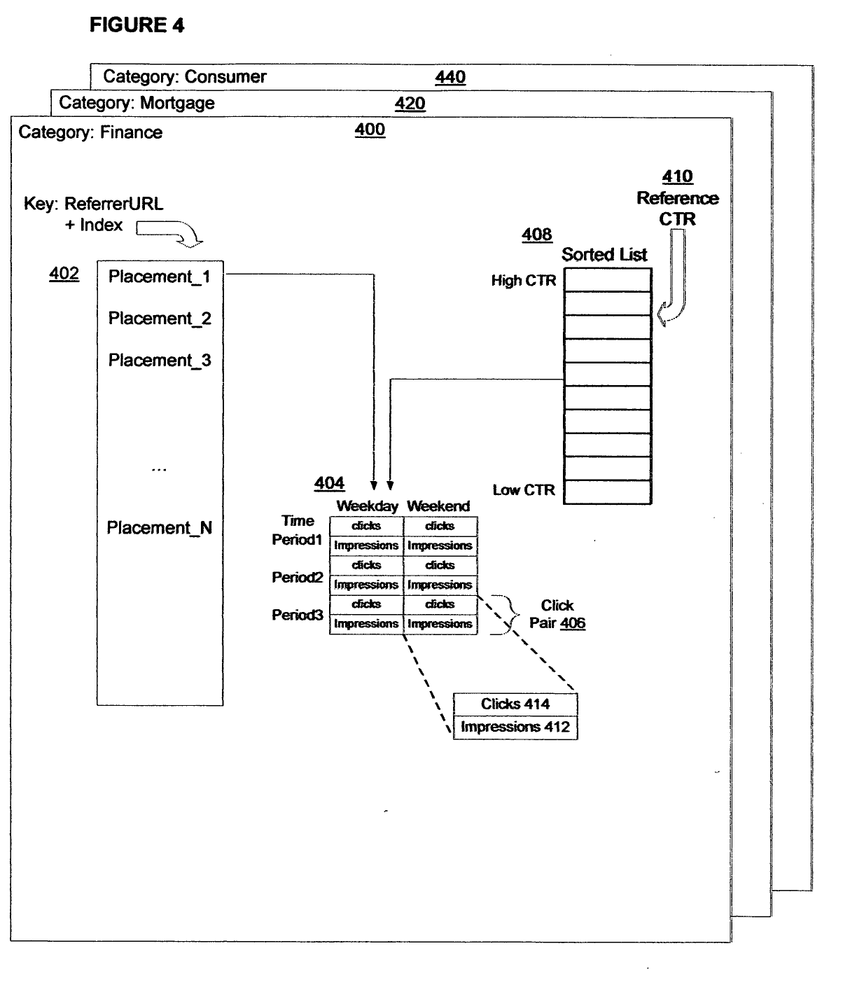

Refer to FIG. 4, which is a diagram of computer software implementing the Ad Placement Scoring agent. Historical statistical counters 406 for computing the real-time click through ratio for every ad placement are stored in a hash table indexed by an ad placement key. This means that for every position (e.g. top of the page, right column, 200 pixels down), of every page (determined by referrer URL) separate counters are maintained in real time by the APSA.

When an ad impression is recorded by the APSA, a key is created using the referrer URL from the HTTP header and a relative position index (e.g. 3^{rd} ad). This key is used to look up the entry in the hash table. If the embodiment keeps separate counter pairs for different times/days 404, then the pair for the current time is selected 406. Finally the impression counter 412 is incremented.

When an ad is clicked on, the key used showing the impression is used to look up the entry in the hash table. If the embodiment keeps separate counter pairs for different times/days, then the pair for the current time is selected. Finally the click counter 414 is incremented.

References to these pairs are maintained in a separate sorted list 408 ordered by click through ratio (CTR=clicks/impressions or “Click-Through-Ratio”) from highest to lowest. In order to make sure that the ratio of clicks to impressions is statistically relevant, only CTR pairs with more than some threshold number of impressions (e.g. hundreds or thousands) are kept in this list.

The “reference CTR” is selected to be a fixed percentage of the up from the bottom of the list (e.g. 80%). For example if there are 1000 placements being monitored, 800 entries from the bottom is the “reference CTR” (e.g. if a reference CTR is 3%, it means 3 of every 100 impressions is clicked on). All other ad placements can now be scored relative to the reference CTR according to an established relationship.

For example, a CTR higher than the reference CTR might be capped at a score of 1.0, and may even be an indication of click fraud. A score of 0.5 might be assigned to a placement ranking in the middle of the sorted list with a CTR of around 1.5%.

In one preferred embodiment, a data object 404 keeps separate counters for different time periods. (e.g. 6 am to 5 pm weekdays, 5 pm to 11 pm on weekends). By keeping track of separate click-through rates for different times, advertisers can determine a fair price to pay at a given time. For example, during stock market hours, Monday through Friday, the statistics would likely be different on financial pages from other times of the day or weekends.

In some embodiments, separate sets of counters will be maintained for different categories of ads shown. (e.g. Financial 400, Mortgage 420, Consumer 440, etc.) This has the advantage that advertisers can weight their eROI using placement data from similar category of ads. For example, Wall Street Journal ads (financial category 400) might do very well on a stock market page, while ads for diapers might do very poorly placed in the identical location. Advertisers are interested in knowing how well their category of ad will do in this location. Note that the category of the placement is also taken into account, since separate counters are maintained for every placement.

The APSA score may be used by an eROI agent, according to an established relationship, to weight the relative values of ads placed in different locations. This has the advantage to an advertiser, that they can spend ad campaign monies on good ad placements, and minimize expenditures for ad locations with known poor performance. Publishers are thus rewarded for good, non-cluttered, easily visible ad placement, where the probability of an ad being clicked on is the highest.

Advertiser Sign-Up Software

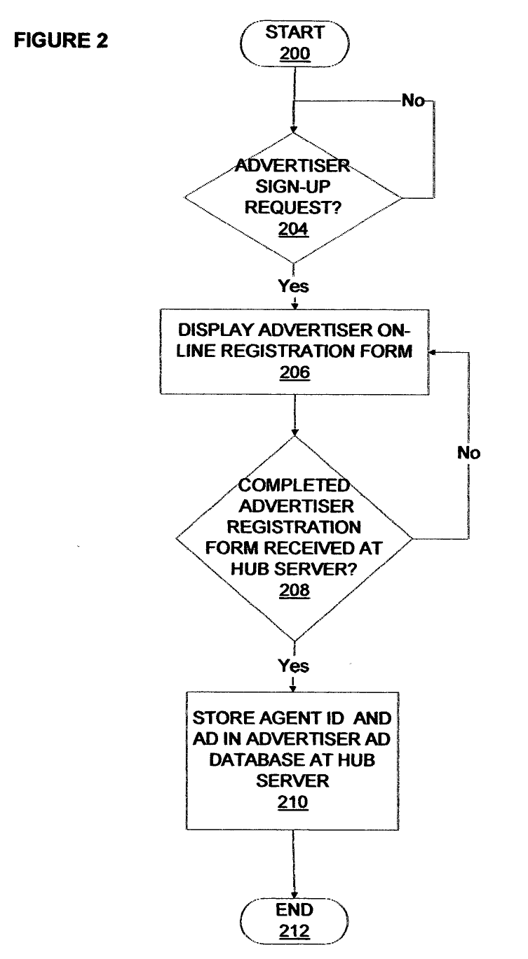

Refer to FIG. 2, which is a flow diagram of computer software implementing advertiser sign-up software. Advertisers may sign up to advertise products or services on a web site maintained by the hub server 100. If an advertisers sign-up request is received 204 at the hub server, an on-line registration form is displayed 206. The advertiser completes the form, which includes provision for an ad for a product or service offered for sale. Additionally, the advertiser can select one of many eROI templates, and enter the value of each component of an expected return on investment formula. Alternatively, an agent (program) or an IP address of a remote agent can be provided. When the completed form is received at the hub server 208, the advertiser ID and the ad or ads are stored in the hub server advertiser ad database along with the advertiser's ID, and registration is complete 212.

Advertiser Ad Display Software

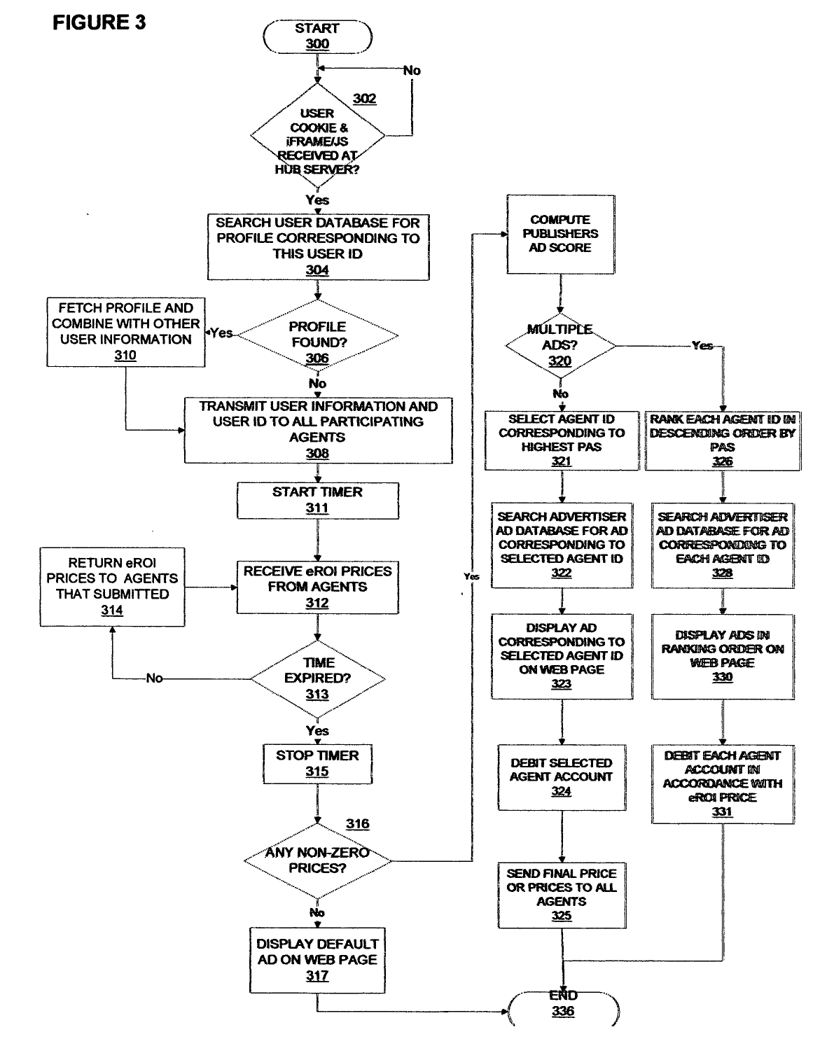

Refer to FIG. 3, which is a flow diagram of computer software implementing advertiser ad display software. When a user browses a web page, a cookie and iFRAME/JS or IMG request is received at the hub server 100. A cookie is a number identifying (ID) a user. The iFRAME/JS/IMG (inline frame/Java script/Image tag) is an area of the screen of the web browser, which can be updated independently. The user ID is used to search 304 the user information database maintained at the hub server, or remotely. If the user has visited any site in the network before, user information may already be stored in the database. If user information is found, 306, it is fetched and combined with other user information 310. The user information is then transmitted to all participating advertisers' agents, 308 (selected advertisers may be eliminated by a site or a user) and a timer is started 311. The timer is on for only a short period of time within the interval after ad space becomes available and the user is identified and, preferably less than a second for banner ads, and minutes for video, during which time eROIs for ad space are received from the agents 312. Each agent representing an advertiser that is interested in this potential buyer sends an eROI price for ad space to the server, 312. For each eROI price received, a publisher's “CRS” is computed. The product of the eROI and CRS is stored in an array.

After a short time interval (not perceptible to a user on whatever medium), the interval expires, 314, and the timer is stopped 315. Receipt of new eROI amounts are cut off when the time expires.

If the mode of operation does not allow for multiple ads to be displayed on the web page 320, and if eROIs have been received, 316, the hub server selects the agent corresponding to the highest PAS, 321. The hub server searches the advertiser ad database for the ad corresponding to this agent ID 322, and displays the ad on the web page 323, or redirects the ad to the advertisers server. The account corresponding to the selected advertiser is debited 324.

If the mode of operation does allow for multiple ads to be displayed on the web page 320, and if eROIs have been received, 316, the hub server ranks each agent ID in descending order by PAS, 326. The hub server searches the advertiser ad database for the ads corresponding to each agent ID 328, and displays (or redirects) the ads in PAS price-descending ranking order on the web page 330. The account of each agent is debited in accordance with the price eROI 331. The final eROI prices are sent to all agents 325.

If no eROIs are received, 316, the hub server displays a default ad on the web page, 317. If user information is not found, 306, the eROI agents still can compute an eROI based on IP address (domain type, location, ISP), time of day, the type of site, etc.

While the invention has been described with ads being served up from the hub server, it will be readily understood that advertisers may have their own server, in which case ads will be served up by redirection from the hub server to that server.

The invention has been described with reference to a web page media format wherein elements of a web page are usually displayed one screen full at a time. The teachings of the invention are applicable to other media formats such as streaming video or streaming audio which enable a player program to begin playing back or displaying media content as data starts flowing in a steam from a server.

While the invention has been particularly shown and described with reference to preferred embodiments thereof, it will be understood by those skilled in the art that the foregoing and other changes in form and detail may be made therein without departing from the scope of the invention.

I claim:

1. A method of allocating web page space comprising:
Identifying a user that is currently accessing said web page;
Providing, to a number of eROI agents, information about said user;
Providing, to a number of eROI agents, statistical information about the placement's historic performance;
Receiving, for a period of time, eROI prices from said agents for space;
Computing a publisher's CRS, and weighting the eROI with this number creating a PAS; and,
Allocating said space in accordance with an established relationship to PAS;
Said period of time being within an interval after said user is identified and before space is allocated.

2. The method of claim 1, wherein said space is advertising (ad) space.

3. The method of claim 1, wherein said period of time is less than one second.

4. The method of claim 1, further comprising:
Supplying a number of eROI templates having provision for entry of a value of each component of an eROI formula, prior to receiving eROI prices from said eROI age for space.

5. The method of claim 1, wherein the publishers CRS is 1.0.

6. The method of claim 2, wherein said step of allocating further comprises:
Allocating said ad space to an eROI agent whose PAS is the highest.

7. The method of claim 2, wherein said step of allocating further comprises:
Arranging a number of ads in said space in a ranking order in accordance with PAS within said period of time.

8. A method of allocating web page space comprising:
Providing, to a number of agents, information about a user that has entered search term(s) on a web page along with the search term(s);
Providing, to a number of eROI agents, statistical information about the placement's historic performance;
Receiving, for a period of time, eROI prices from said agents for space on a results web page; and,
Computing a publisher's CRS, and weighting the eROI with this number creating a PAS; And,
Allocating said space on said results web page in a ranking order in accordance with PAS received from said agents within said period of time;
Said period of time being within an interval after said user is identified and said space is allocated.

9. The method of claim 8, further comprising:
Supplying a number of eROI templates having provision for entry of a value of each component of an eROI formula, prior to receiving eROI prices from said eROI agents for space.

10. The method of claim 8, wherein said period of time is less than one second.

11. The method of claim 8, wherein the publishers CRS is 1.0.

12. The method of claim 8, wherein said step of allocating further comprises:
Allocating said ad space to an eROI agent whose PAS is the highest.

13. The method of claim 8, wherein said step of allocating further comprises:
Arranging a number of ads in said space in a ranking order in accordance with PAS within said period of time.

14. A method of computing the relative value of an ad shown in a specific placement comprising:
Counting the number of ad impressions shown on a specific place on a specific page of a web site, during different times of the day/week;
Counting the number of ads clicked on in a specific place on a specific page of a web site, during different times of the day/week;
Maintaining a sorted list of ad placement click-through-ratios, and picking a reference value;
Providing a relative score for an ad placement by comparing a specific ad placement with other placements.

15. The method of claim 14, wherein said step further comprises:
Maintaining separate counters for different times of the day and different days of the week.

16. The method of claim 14, wherein said step further comprises:
Maintaining separate counters for different categories of advertisers.
